(19) United States
(12) Patent Application Publication
(10) Pub. No.: US 2013/0325564 A1
(43) Pub. Date: Dec. 5, 2013

(54) SYSTEMS AND METHODS FOR ALLOWING CAR OWNERS TO MAXIMIZE UTILITY OF PARKING SPACE

(71) Applicant: YAT WAI EDWIN KWONG, Hong Kong (HK)

(72) Inventor: YAT WAI EDWIN KWONG, Hong Kong (HK)

(21) Appl. No.: 13/487,036

(22) Filed: Jun. 1, 2012

(51) Int. Cl. B60Q 1/48; G06Q 50/30; H04N 7/18

(52) U.S. Cl. 705/13

(57) ABSTRACT

Systems and methods are provided for allowing car owners to maximize utility of parking space. In one embodiment, a system is provided. The system includes a RFID reader placed from one side of the parking space; a camera installed in the parking space, wherein the camera is used to capture license plate information of parking cars; a first RFID tag placed from another side of the parking space; a second RFID tag placed in a car.

### FIELD OF THE INVENTION

This invention generally relates to parking space security and metering. Specifically, this invention relates to allowing owners of the parking space to park while still charging parking space when the owners are away from the parking space.

### BACKGROUND OF THE INVENTION

Typically, parking space can be very competitive, especially in urban areas. To many people, parking in congested urban areas can be troublesome. Finding a parking space can be highly time-consuming. Even if a parking can be found, the parking costs can sometimes be quite expensive. To car park owners, learning how to accommodate car parks can be beneficial not just to the car park owners themselves, but also the society in reducing the exceedingly strong demand for parking space. How to solve such potentially large numbers of motor vehicles in small geographic areas is a question for many urban planners in the world. Some authorities may decide to build minimum numbers of motor vehicle parking spaces for new housing and commercial developments, and may also plan its location and distribution to influence its convenience and accessibility. The costs or subsidies of such parking accommodations can become very expensive and they are often not deemed very practical. In big parking lots, car park is often shared. A car may be parked while the car owner can get off to go shopping. The stop may be temporary and often stay just for a short period of time like a few hours. When the car leaves, another car may fill the empty spot promptly, so that utilization can be fully achieved. This concept of sharing car park is well established in commercial premises. In personal premises, however, the concept of car sharing is less common. For example, in a household premise, a car park may likely be left vacated during the day as soon as the car leaves the garage. The car park would be left vacated until when the car owner returns to the garbage. If the car park can be filled up by other cars during this time, and leave when the owner returns, maximum utility can be achieved. In view of the foregoing, there is a demand to use the car park to its maximum, especially when the car owner is away from the parking space.

### SUMMARY OF THE INVENTION

According to embodiments of the present invention, a system is provided for allowing car owners to maximize utility of parking space by allowing other cars to park on the parking space when the parking space is available while ensuring the other cars vacate the parking space when the car owners return at a later time. In one embodiment, a system comprises: a RFID reader placed from one side of the parking space, wherein the RFID reader is used to detect if any invalid parking has occurred; a camera installed in the parking space, wherein the camera is used to capture license plate information of parking cars; a first RFID tag placed from another side of the parking space; a second RFID tag placed in a car, wherein the car belongs to an owner of the parking space; a computer server connecting the RFID reader, and the first and second RFID tags; a mobile device associated with a car belonging to a person other than the owner, wherein the mobile device is configured to dynamically registering the parking space with the computer server when the parking space is available; a boot associated with the parking space, wherein the boot can dynamically lock up unregistered vehicles, or lock up any registered vehicles that have expired, after the owner's car has returned to the parking space; a processor; and a memory storing instructions that cause the processor to execute a method.

Many embodiments can be provided to implement the method. In one embodiment, the method comprises: detecting, by the RFID reader and the second RFID tag, that the owner's car has left the parking space so that the computer server can make the parking space available for others to park; detecting that the car belonging to the person other than the owner has successfully registered the parking space, wherein the registration includes: receiving license plate identification number from the other owner; receiving payment information from the other owner; and receiving contact information from the other owner, wherein the contact information is used to: inform the other owner regarding when the owner's car is coming back and how such information would affect parking charges of the other car; and warn the other owner that the owner's car has come back to the parking space and the other car is going to be lock up soon; detecting that the car belonging to the person other than the owner has entered the parking space and parked successfully the parking space by verifying the license plate information of the other car via the camera installed in the parking space, the computer server begins to charge the other owner; detecting that the car belonging to the person other than the owner has left the parking space, the computer server stops charging the other owner; detecting that a car without prior registration has entered the parking space and parked in the parking space by verifying the license plate information of the other car via the camera installed in the parking space, the computer server warning the car to get registration and risks being locked up; and after warning, locking up the car that is without prior registration.

Other embodied methods can be provided to exemplify the inventive features of this invention, comprising: detecting, by the RFID reader and the second RFID tag, that the owner's car has left the parking space so that the computer server can make the parking space available for others to park; detecting that the car belonging to the person other than the owner has successfully registered the parking space, wherein the registration includes: receiving license plate identification number from the other owner; receiving payment information from the other owner; and receiving contact information from the other owner, wherein the contact information is used to: inform the other owner regarding when the owner's car is coming back and how such information would affect parking charges of the other car; and warn the other owner that the owner's car has come back to the parking space and the other car is going to be lock up soon; detecting that the car belonging to the person other than the owner has entered the parking space and parked successfully the parking space by verifying the license plate information of the other car via the camera installed in the parking space, the computer server begins to charge the other owner; detecting, via the GPS of the car, that the car belonging to the owner is coming back to the parking space soon; and informing the other car owner: to vacate the parking space soon to yield the parking space to the car owner; that the charge of the parking space is increasing because the car owner is coming back; and that the other car may be locked up if the other car fails to move out from the parking space in time, when the car owner has returned.

Alternatively, methods may also include: detecting, by the RFID reader and the second RFID tag, that the owner's car has left the parking space so that the computer server can make the parking space available for others to park; detecting that the car belonging to the person other than the owner has successfully registered the parking space, wherein the registration includes: receiving license plate identification number from the other owner; receiving payment information from the other owner; and receiving contact information from the other owner, wherein the contact information is used to: inform the other owner regarding when the owner's car is coming back and how such information would affect parking charges of the other car; and warn the other owner that the owner's car has come back to the parking space and the other car is going to be lock up soon; detecting that the car belonging to the person other than the owner has entered the parking space and parked successfully the parking space by verifying the license plate information of the other car via the camera installed in the parking space, the computer server begins to charge the other owner; detecting, via the GPS of the car, that the car belonging to the owner is coming back to the parking space soon; informing the other car owner: to vacate the parking space soon to yield the parking space to the car owner; that the charge of the parking space is increasing because the car owner is coming back; and that the other car may be locked up if the other car fails to move out from the parking space in time, when the car owner has returned; continuing to increase the charge to the other car owner; continuing to send warning messages to the other car owner to urge the other car owner to leave the parking space; and when the car owner returns to the parking space, locking up the other car if the other car still occupies the parking space, wherein the car owner would park in a different parking space that is being available, and increasing the charge to the other car to offset the charge by the different parking space.

### BRIEF DESCRIPTION OF THE DRAWINGS

FIG. 1 illustrates a car parking system, in accordance with one embodiment of the present invention.

### DETAILED DESCRIPTION

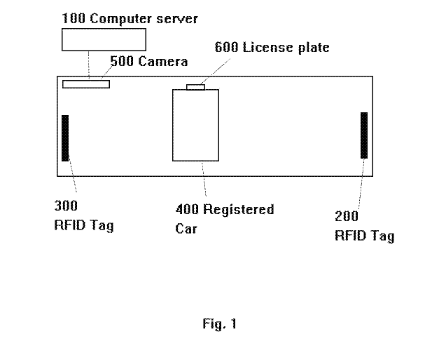

Referring to FIG. 1 to illustrate an example of this invention. In the drawing, a system is provided for allowing car owners to maximize utility of parking space by allowing other cars to park on the parking space when the parking space is available while ensuring the other cars vacate the parking space when the car owners return at a later time. The system comprises: a RFID reader placed from one side of the parking space, wherein the RFID reader is used to detect if any invalid parking has occurred; a camera installed in the parking space, wherein the camera is used to capture license plate information of parking cars; a first RFID tag placed from another side of the parking space; a second RFID tag placed in a car.

It is noted in this invention that a car belongs to an owner of the parking space; whereas a computer server connecting the RFID reader, and the first and second RFID tags; a mobile device associated with a car belonging to a person other than the owner. The mobile device is configured to dynamically registering the parking space with the computer server when the parking space is available; a boot associated with the parking space, wherein the boot can dynamically lock up unregistered vehicles, or lock up any registered vehicles that have expired, after the owner's car has returned to the parking space; a processor; and a memory storing instructions that cause the processor to execute a method, comprising: detecting, by the RFID reader and the second RFID tag, that the owner's car has left the parking space so that the computer server can make the parking space available for others to park; detecting that the car belonging to the person other than the owner has successfully registered the parking space, wherein the registration includes: receiving license plate identification number from the other owner; receiving payment information from the other owner; and receiving contact information from the other owner, wherein the contact information is used to: inform the other owner regarding when the owner's car is coming back and how such information would affect parking charges of the other car; and warn the other owner that the owner's car has come back to the parking space and the other car is going to be lock up soon; detecting that the car belonging to the person other than the owner has entered the parking space and parked successfully the parking space by verifying the license plate information of the other car via the camera installed in the parking space, the computer server begins to charge the other owner; detecting that the car belonging to the person other than the owner has left the parking space, the computer server stops charging the other owner; detecting that a car without prior registration has entered the parking space and parked in the parking space by verifying the license plate information of the other car via the camera installed in the parking space, the computer server warning the car to get registration and risks being locked up; and after warning, locking up the car that is without prior registration.

In yet another example, a different system is provided. The system includes a RFID reader placed from one side of the parking space, wherein the RFID reader is used to detect if any invalid parking has occurred; a camera installed in the parking space, wherein the camera is used to capture license plate information of parking cars; a first RFID tag placed from another side of the parking space; a second RFID tag placed in a car, wherein the car belongs to an owner of the parking space; a GPS receiver included in the car, wherein the GPS receiver is used to report whether the car is coming back to the parking space soon; a computer server connecting the RFID reader, and the first and second RFID tags; a mobile device associated with a car belonging to a person other than the owner.

Mobile devices are used to complement the inventive system. In this case, the mobile device is configured to dynamically registering the parking space with the computer server when the parking space is available; a boot associated with the parking space, wherein the boot can dynamically lock up unregistered vehicles, or lock up any registered vehicles that have expired, after the owner's car has returned to the parking space; a processor; and a memory storing instructions that cause the processor to execute a method, comprising:
detecting, by the RFID reader and the second RFID tag, that the owner's car has left the parking space so that the computer server can make the parking space available for others to park; detecting that the car belonging to the person other than the owner has successfully registered the parking space.

The registration includes receiving license plate identification number from the other owner; receiving payment information from the other owner; and receiving contact information from the other owner, wherein the contact information is used to: inform the other owner regarding when the owner's car is coming back and how such information would affect parking charges of the other car; and warn the other owner that the owner's car has come back to the parking space and the other car is going to be lock up soon; detecting that the car belonging to the person other than the owner has entered the parking space and parked successfully the parking space by verifying the license plate information of the other car via the camera installed in the parking space, the computer server begins to charge the other owner; detecting, via the GPS of the car, that the car belonging to the owner is coming back to the parking space soon; and informing the other car owner: to vacate the parking space soon to yield the parking space to the car owner; that the charge of the parking space is increasing because the car owner is coming back; and that the other car may be locked up if the other car fails to move out from the parking space in time, when the car owner has returned.

The RFID reader is used to detect if any invalid parking has occurred; a camera installed in the parking space, wherein the camera is used to capture license plate information of parking cars; a first RFID tag placed from another side of the parking space; a second RFID tag placed in a car, wherein the car belongs to an owner of the parking space; a GPS receiver included in the car, wherein the GPS receiver is used to report whether the car is coming back to the parking space soon; a computer server connecting the RFID reader, and the first and second RFID tags; a mobile device associated with a car belonging to a person other than the owner, wherein the mobile device is configured to dynamically registering the parking space with the computer server when the parking space is available; a boot associated with the parking space, wherein the boot can dynamically lock up unregistered vehicles, or lock up any registered vehicles that have expired, after the owner's car has returned to the parking space; a processor; and a memory storing instructions that cause the processor to execute a method, comprising: detecting, by the RFID reader and the second RFID tag, that the owner's car has left the parking space so that the computer server can make the parking space available for others to park; detecting that the car belonging to the person other than the owner has successfully registered the parking space, wherein the registration includes: receiving license plate identification number from the other owner; receiving payment information from the other owner; and receiving contact information from the other owner, wherein the contact information is used to: inform the other owner regarding when the owner's car is coming back and how such information would affect parking charges of the other car; and warn the other owner that the owner's car has come back to the parking space and the other car is going to be lock up soon; detecting that the car belonging to the person other than the owner has entered the parking space and parked successfully the parking space by verifying the license plate information of the other car via the camera installed in the parking space, the computer server begins to charge the other owner; detecting, via the GPS of the car, that the car belonging to the owner is coming back to the parking space soon; informing the other car owner: to vacate the parking space soon to yield the parking space to the car owner; that the charge of the parking space is increasing because the car owner is coming back; and that the other car may be locked up if the other car fails to move out from the parking space in time, when the car owner has returned; continuing to increase the charge to the other car owner; continuing to send warning messages to the other car owner to urge the other car owner to leave the parking space; and when the car owner returns to the parking space, locking up the other car if the other car still occupies the parking space, wherein the car owner would park in a different parking space that is being available, and increasing the charge to the other car to offset the charge by the different parking space.

What is claimed is:

1. A system for allowing car owners to maximize utility of parking space by allowing other cars to park on the parking space when the parking space is available while ensuring the other cars vacate the parking space when the car owners return at a later time, comprising:
a RFID reader placed from one side of the parking space, wherein the RFID reader is used to detect if any invalid parking has occurred;
a camera installed in the parking space, wherein the camera is used to capture license plate information of parking cars;
a first RFID tag placed from another side of the parking space;
a second RFID tag placed in a car, wherein the car belongs to an owner of the parking space;
a computer server connecting the RFID reader, and the first and second RFID tags;
a mobile device associated with a car belonging to a person other than the owner, wherein the mobile device is configured to dynamically registering the parking space with the computer server when the parking space is available;
a boot associated with the parking space, wherein the boot can dynamically lock up unregistered vehicles, or lock up any registered vehicles that have expired, after the owner's car has returned to the parking space;
a processor; and
a memory storing instructions that cause the processor to execute a method.

2. The system of claim 1, wherein the method comprises:
detecting, by the RFID reader and the second RFID tag, that the owner's car has left the parking space so that the computer server can make the parking space available for others to park;
detecting that the car belonging to the person other than the owner has successfully registered the parking space, wherein the registration includes:
receiving license plate identification number from the other owner;
receiving payment information from the other owner; and
receiving contact information from the other owner, wherein the contact information is used to:
inform the other owner regarding when the owner's car is coming back and how such information would affect parking charges of the other car; and
warn the other owner that the owner's car has come back to the parking space and the other car is going to be lock up soon;
detecting that the car belonging to the person other than the owner has entered the parking space and parked successfully the parking space by verifying the license plate information of the other car via the camera installed in the parking space, the computer server begins to charge the other owner;
detecting that the car belonging to the person other than the owner has left the parking space, the computer server stops charging the other owner;
detecting that a car without prior registration has entered the parking space and parked in the parking space by verifying the license plate information of the other car via the camera installed in the parking space, the computer server warning the car to get registration and risks being locked up; and
after warning, locking up the car that is without prior registration.

3. The system of claim 1, wherein the method comprises:
detecting, by the RFID reader and the second RFID tag, that the owner's car has left the parking space so that the computer server can make the parking space available for others to park;
detecting that the car belonging to the person other than the owner has successfully registered the parking space, wherein the registration includes:
receiving license plate identification number from the other owner;
receiving payment information from the other owner; and
receiving contact information from the other owner, wherein the contact information is used to:
inform the other owner regarding when the owner's car is coming back and how such information would affect parking charges of the other car; and
warn the other owner that the owner's car has come back to the parking space and the other car is going to be lock up soon;
detecting that the car belonging to the person other than the owner has entered the parking space and parked successfully the parking space by verifying the license plate information of the other car via the camera installed in the parking space, the computer server begins to charge the other owner;
detecting, via the GPS of the car, that the car belonging to the owner is coming back to the parking space soon; and
informing the other car owner:
to vacate the parking space soon to yield the parking space to the car owner;
that the charge of the parking space is increasing because the car owner is coming back; and
that the other car may be locked up if the other car fails to move out from the parking space in time, when the car owner has returned.

4. The system of claim 1, wherein the method comprises:
detecting, by the RFID reader and the second RFID tag, that the owner's car has left the parking space so that the computer server can make the parking space available for others to park;
detecting that the car belonging to the person other than the owner has successfully registered the parking space, wherein the registration includes:
receiving license plate identification number from the other owner;
receiving payment information from the other owner; and
receiving contact information from the other owner, wherein the contact information is used to:
inform the other owner regarding when the owner's car is coming back and how such information would affect parking charges of the other car; and
warn the other owner that the owner's car has come back to the parking space and the other car is going to be lock up soon;
detecting that the car belonging to the person other than the owner has entered the parking space and parked successfully the parking space by verifying the license plate information of the other car via the camera installed in the parking space, the computer server begins to charge the other owner;
detecting, via the GPS of the car, that the car belonging to the owner is coming back to the parking space soon;
informing the other car owner:
to vacate the parking space soon to yield the parking space to the car owner;
that the charge of the parking space is increasing because the car owner is coming back; and
that the other car may be locked up if the other car fails to move out from the parking space in time, when the car owner has returned;
continuing to increase the charge to the other car owner;
continuing to send warning messages to the other car owner to urge the other car owner to leave the parking space; and
when the car owner returns to the parking space, locking up the other car if the other car still occupies the parking space, wherein the car owner would park in a different parking space that is being available, and increasing the charge to the other car to offset the charge by the different parking space.
